(19) United States
(12) Patent Application Publication
(10) Pub. No.: US 2013/0333843 A1
(43) Pub. Date: Dec. 19, 2013

(54) APPARATUS FOR MANUFACTURING CAMERA MODULE

(71) Applicant: SAMSUNG ELECTRO-MECHANICS CO., LTD., Suwon (KR)

(72) Inventors: Byung Jae KIM, Suwon (KR); Sung Jae Lee, Suwon (KR); Sang Jin Kim, Suwon (KR); Hoon Taek Kang, Suwon (KR); Seung Hee Cho, Suwon (KR)

(73) Assignee: SAMSUNG ELECTRO-MECHANICS CO., LTD., Suwon (KR)

(21) Appl. No.: 13/826,826

(22) Filed: Mar. 14, 2013

(30) Foreign Application Priority Data
Jun. 18, 2012 (KR) 10-2012-0064939

(51) Int. Cl. B29C 65/80

(52) U.S. Cl. CPC B29C 65/80
USPC 156/362

(57) ABSTRACT

Disclosed herein is an apparatus for manufacturing a camera module, the apparatus including: a base jig holding a PCB from below; a rim tool picking up an image sensor and attaching the image sensor onto the PCB; and a housing bonding tool picking up a housing assembly and attaching the housing assembly onto the PCB so that the image sensor attached onto the PCB is received in the housing assembly, wherein a PCB holding unit is formed integrally with an image sensor pickup part of the rim tool outside the image sensor pickup part, the PCB holding unit being contacted with the PCB to hold the PCB when the image sensor is picked up by the image sensor pickup part and attached onto the PCB.

### CROSS REFERENCE(S) TO RELATED APPLICATIONS

This application claims the benefit under 35 U.S.C. Section 119 of Korean Patent Application Serial No. 10-2012-0064939, entitled “Apparatus for Manufacturing Camera Module” filed on Jun. 18, 2012, which is hereby incorporated by reference in its entirety into this application.

### BACKGROUND OF THE INVENTION

1. Technical Field

The present invention relates to an apparatus for manufacturing a camera module, and more particularly, to an apparatus for manufacturing a camera module, capable of improving a structure of a rim tool, which picks up an image sensor and attaching the image sensor onto a PCB, to thereby make the mounting levels of a lens housing module and the image sensor equal to each other.

2. Description of the Related Art

A chip on board (COB) method is most frequently and widely used in manufacturing a camera module. This COB method is largely composed of a dicing (wafer sawing) process, a D/A (die attach) process, a W/B (wire bonding) process, and an H/A (housing attach) process, and the respective processes will be described as follows.
Dicing Process: Image sensors on a bare wafer are attached and fixed on a tape of a wafer ring, and a specific position of a pattern is moved in X and Y directions while a blade made of diamond particles is rotated at a high speed, to thereby separate the image sensors from each other.
D/A Process: An epoxy is applied on a PCB, and then the image sensors respectively separated in the dicing process are repeatedly attached onto predetermined positions of the PCB and cured while a specific position pattern formed on the PCB is image-recognized.
W/B process: The image sensors and the PCB are electrically connected by connecting between pads of the image sensors and the PCB with gold wires using a capillary.
H/A Process: The epoxy is applied at an edge of the PCB on which the image sensors are mounted, and then housing modules with lenses are repeatedly attached to predetermined positions and cured.

Meanwhile, in manufacturing a camera module through the above processes, high-pixel modules having even twelve mega pixels have been developed. Also, the number of pixels of the modules is expected to continuously increase in the years ahead. The resolution problem is one of problems caused by rapidly increasing the number of pixels.

As shown in FIG. 1A, the most idealistic resolution is obtained when the central optical axis of lenses 102 makes an angle of 90° with respect to a surface of an image sensor 104 receiving the light. However, as shown in FIG. 1B, when the optical axis of the lenses 102 does not make an angle of 90° with the image sensor 104 due to tilting of the image sensor 104, the resolution at a specific edge of an image may be degraded, resulting in degrading the resolution of the overall image. In FIGS. 1A and 1B, reference number 101 indicates a housing assembly; 103 indicates an infrared (IR) filter; and 105 indicates a PCB.

As such, the tilting of the image sensor 104 that causes degradation of the resolution may be complexly generated during a package process, due to the combination between the lenses 102 themselves, flatness of the PCB 105, the tilt in fitting an auto-focusing actuator, or the like.

### RELATED ART DOCUMENTS

### Patent Documents

(Patent Document 1) Korean Patent Laid-Open Publication No. 10-2009-0015697

(Patent Document 1) Japanese Patent Laid-Open Publication No. 2011-151551

### SUMMARY OF THE INVENTION

An object of the present invention is to provide an apparatus for manufacturing a camera module, capable of fundamentally solving the problem in that the tilt of an image sensor is changed according to the tilt of a PCB, by making the mounting levels of a lens housing module and the image sensor equal to each other to thereby vary the mounting tilt of the image sensor according to the tilt of a PCB in a die attach (D/A) process.

According to an exemplary embodiment of the present invention, there is provided an apparatus for manufacturing a camera module, the apparatus including: a base jig holding a PCB from below; a rim tool picking up an image sensor and attaching the image sensor onto the PCB; and a housing bonding tool picking up a housing assembly and attaching the housing assembly onto the PCB so that the image sensor attached onto the PCB is received in the housing assembly, wherein a PCB holding unit is formed integrally with an image sensor pickup part of the rim tool outside the image sensor pickup part, the PCB holding unit being contacted with the PCB to hold the PCB when the image sensor is picked up by the image sensor pickup part and attached onto the PCB.

The PCB holding unit may be composed of, based on a central point of the image sensor pickup part of the rim tool, a horizontal plane part extended toward an outside of the image sensor pickup part in all directions by a predetermined width, and a vertical member formed downwardly from an edge of the horizontal plane part perpendicularly to the horizontal plane part by a predetermined length.

The vertical member may be formed in a type of barrier wall, which entirely surrounds the image sensor pickup part.

The vertical member may be formed in a type of one pair of wall surface structures at least facing each other outside of the image sensor pickup part.

The vertical member be formed in a type of plural pillar members outside the image sensor pickup part.

The image sensor pickup part may be constituted in a vacuum type or a grip type.

The image sensor pickup part may have contact protrusions constituted in any one of a square shape, a circular shape, and a discontinuous rod shape.

### BRIEF DESCRIPTION OF THE DRAWINGS

FIGS. 1A and 1B are views schematically explaining that the resolution is degraded due to the tilt of an image sensor, in a manufacturing process of a camera module.

FIG. 2 is a view explaining a procedure of manufacturing a camera module by a die attach (D/A) method.

FIGS. 3A to 3C are views explaining that an error in verticality occurs between an image sensor and a surface of a lens due to flatness and warpage of a PCB, in a manufacturing process of a camera module.

FIGS. 4A and 4B are views explaining that an error in verticality occurs between an image sensor and a surface of a lens due to the deviation generated at the time of fitting (pressing) a lens, in a manufacturing process of a camera module.

FIGS. 5A and 5B are views explaining that an error in verticality occurs between an image sensor and a surface of a lens due to the deviation generated at the time of fitting an autofocus actuator, in a manufacturing process of a camera module.

FIGS. 6A and 6B are views explaining that an error in verticality occurs between an image sensor and a surface of a lens due to the tolerance generated by the degree at which a jig is processed and the combination of the jig with equipment.

FIG. 7 is a view showing that an image sensor is picked up and attached onto a PCB by a rim tool of an apparatus for manufacturing a camera module according to an exemplary embodiment of the present invention.

FIG. 8 is a side view showing a structure of the rim tool of the apparatus for manufacturing a camera module according to an exemplary embodiment of the present invention.

FIG. 9 is a bottom view showing the structure of the rim tool of the apparatus for manufacturing a camera module according to an exemplary embodiment of the present invention.

FIGS. 10A and 10B are views explaining a state where accumulative tolerance is generated when a D/A process is performed by an apparatus for manufacturing a camera module of the prior art.

FIGS. 11A and 11B are views explaining a state where accumulative tolerance is overcome when a D/A process is performed by the apparatus for manufacturing a camera module of the present invention.

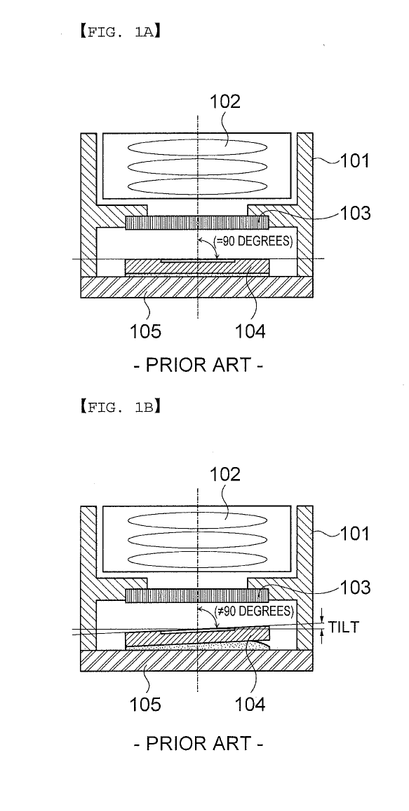

### DESCRIPTION OF THE PREFERRED EMBODIMENTS

Terms and words used in the present specification and claims are not to be construed as a general or dictionary meaning but are to be construed as meaning and concepts meeting the technical ideas of the present invention based on a principle that the inventors can appropriately define the concepts of terms in order to describe their own inventions in best mode.

Thorough the specification, unless explicitly described to the contrary, the word “comprise” and variations such as “comprises” or “comprising”, will be understood to imply the inclusion of stated elements but not the exclusion of any other elements. In addition, the terms “-er”, “-or”, “module”, and “unit” described in the specification mean units for processing at least one function and operation, and can be implemented by hardware components or software components and combinations thereof.

Exemplary embodiments of the present invention will now be described in detail with reference to the accompanying drawings.

Here, prior to the explanation of exemplary embodiments of the present invention, the reason why the tilt is generated in a general manufacturing process of the camera module and the types thereof will be first described for better understanding.

According to the die attach (D/A) process in the manufacturing process of the camera module, as described above, a predetermined amount of epoxy is applied on a PCB in the predetermined shape, and then the image sensors respectively separated after completion of dicing are picked up and mounted onto predetermined positions of the PCB while a pattern formed on the PCB is image-recognized.

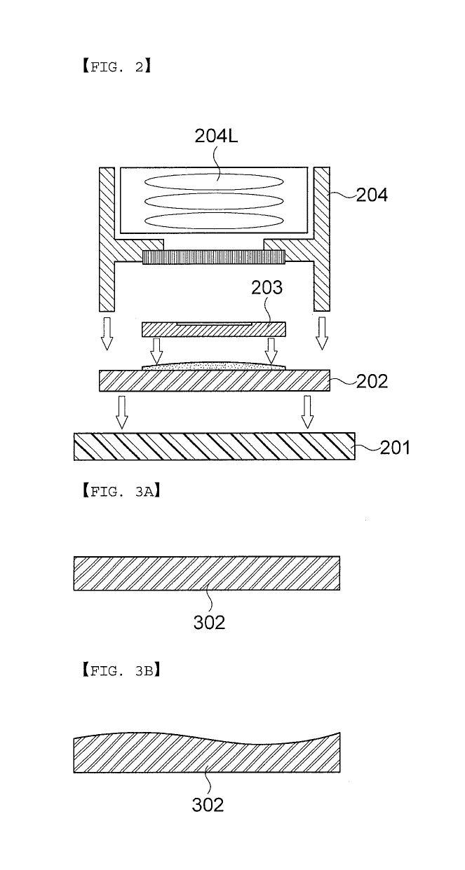

In the die attach (D/A) process of the related art, as shown in FIG. 2, a PCB 202 is stacked above a base jig 201 while a bottom surface of the PCB 202 is a reference surface based on an upper surface of the base jig 201 inside a machine. Then, an image sensor 203 is attached thereon, and finally, an autofocus actuator 204 (that is, a housing assembly including a lens module) is fitted thereon.

However, in the manufacturing process of the camera module as above, the important factor for determining the image resolution of the camera is verticality between an incident angle of the light entering a lens and a surface of the lens (an active area) of the image sensor that receives the light.

For achieving this verticality, flatness and warpage of the PCB, fit-ability of the lens, precision of the autofocus actuator, precision of facilities, and tolerance of the jig need to be near “0” (zero). However, the current technical level falls short of this degree and the accumulative tolerance resulting therefrom continuously causes a resolution defect. Factors causing the above-described resolution defect (degradation) will be described more with reference to the drawings.

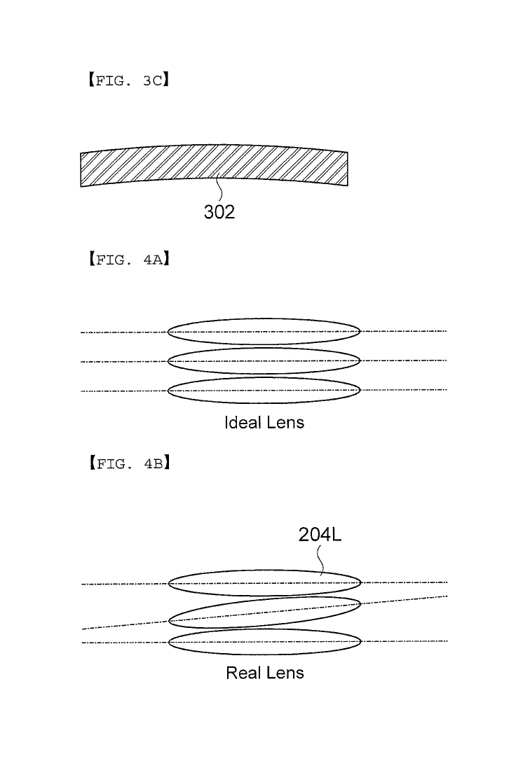

First, there is a limit in securing flatness due to concentration of patterns inside layers of the PCB and deviation in soldering resist (SR) coating, and thus, a surface of the PCB 302 is not flat as shown in FIG. 3B, or the PCB 302 is warped as shown in FIG. 3C. Therefore, when an image sensor is attached onto the PCB 302, the tilting is generated, and thus, an error in verticality occurs between the image sensor and a surface of the lens.

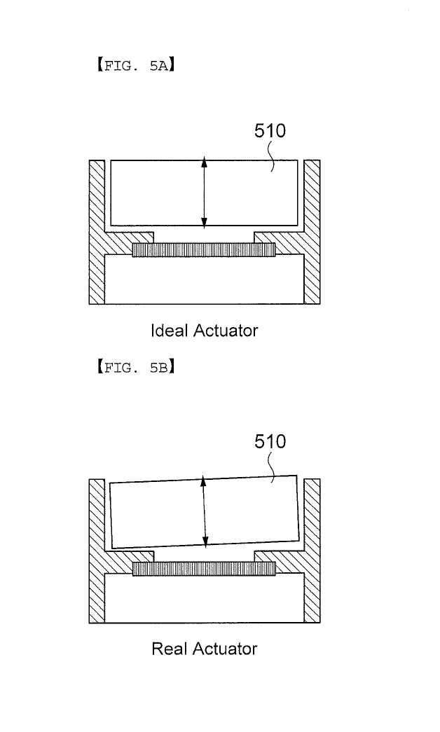

In addition, as shown in FIG. 4B, an error in verticality occurs between the image sensor and the surface of the lens due to deviation generated at the time of fitting (pressing) a lens 204L.

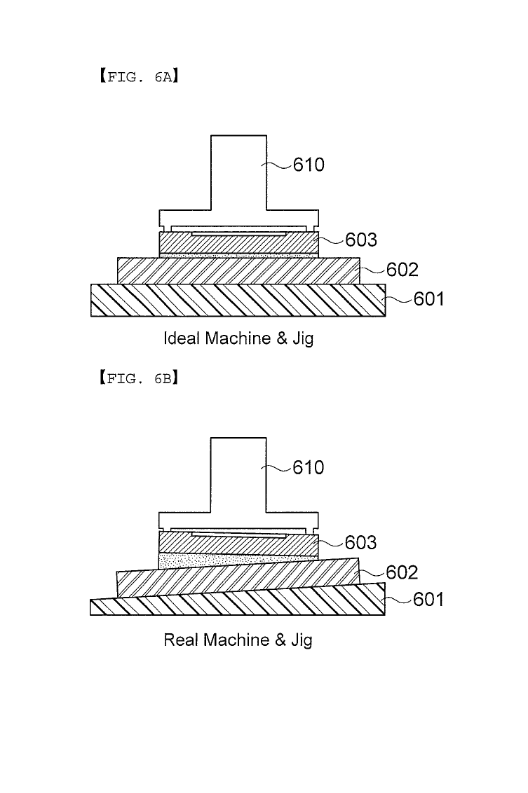

In addition, as shown in FIG. 5B, an error in verticality occurs between the image sensor and the surface of the lens due to deviation generated at the time of fitting an autofocus actuator 510.

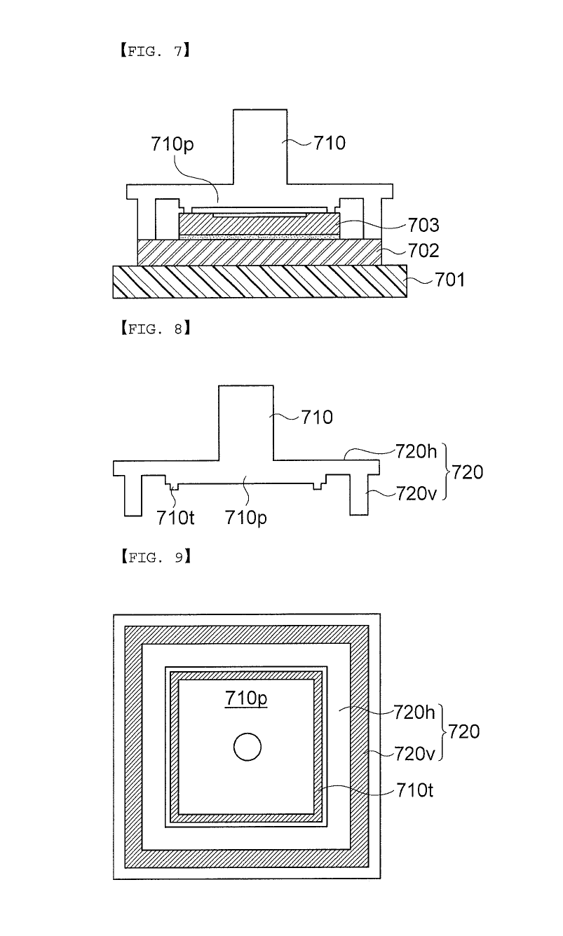

In addition, as shown in FIG. 6B, an error in verticality occurs between an image sensor and the surface of the lens due to the tolerance generated by the degrees at which a jig (base jig) 601 and a rim tool (pickup tool) 610 are processed and the combinations of the jig and the rim tool with equipment.

The present invention is made considering factors of error in verticality as described above, and thus, there is provided an apparatus for manufacturing a camera module, capable of fundamentally solving the problem in that the tilt of an image sensor is changed according to the tilt of a PCB, by making the mounting levels of a lens housing module and the image sensor equal to each other to thereby vary the mounting tilt of the image sensor according to the tilt of a PCB in a die attach (D/A) process.

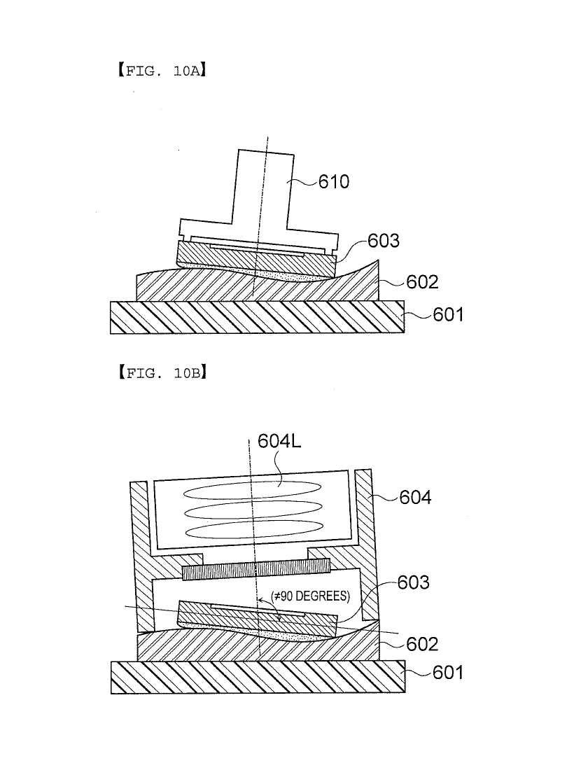

FIGS. 7 to 9 show an apparatus for manufacturing a camera module according to an exemplary embodiment of the present invention. FIG. 7 is a view showing that an image sensor is picked up and attached onto a PCB by a rim tool; FIG. 8 is a side view showing a structure of the rim tool; and FIG. 9 is a bottom view showing the structure of the rim tool.

Referring to FIGS. 7 to 9, an apparatus for manufacturing a camera module according to the present invention may include a base jig 701 holding a PCB 702 from below; a rim tool 710 picking up an image sensor 703 and attaching the image sensor 703 onto the PCB 702; and a housing bonding tool (not shown) picking up a housing assembly and attaching the housing assembly onto the PCB 702 such that the image sensor attached onto the PCB 702 is contained inside the housing assembly.

Particularly, a PCB holding unit 720 is formed integrally with an image sensor pickup part 710p of the rim tool 710 outside the image sensor pickup part 710p. When the image sensor 703 is picked up by the image sensor pickup part 710p and attached onto the PCB 702, the PCB holding unit 720 is contacted with the PCB 702 to hold the PCB 702.

Here, the PCB holding unit 720 is composed of, based on a central point of the image sensor pickup part 710p of the rim tool 710, a horizontal plane part 720h extended toward an outside of the image sensor pickup part 710p in all directions by a predetermined width, and a vertical member 720v formed downwardly from an edge of the horizontal plane part 720h perpendicularly to the horizontal plane part 720h by a predetermined length.

In addition, the vertical member 720v may be formed in a type of barrier wall, which entirely surrounds the image sensor pickup part 710p.

Alternatively, the vertical member 720v may be formed in a type of one pair of wall surface structures at least facing each other outside of the image sensor pickup part 710p (for example, only two wall surfaces facing each other of four wall surfaces that entirely surround the image sensor pickup part 710p).

Alternatively, the vertical member 720v may be formed in a type of plural pillar members outside the image sensor pickup part 710p.

In addition, the image sensor pickup part 710p may be constituted in a vacuum type or a grip type.

In addition, contact protrusions 710t of the image sensor pickup part 710p may be constituted in any one of a square shape, a circular shape, and a discontinuous rod shape.

Meanwhile, FIGS. 11A to 11B show that a D/A process is performed by using an apparatus for manufacturing a camera module according to the related art and the present invention, respectively.

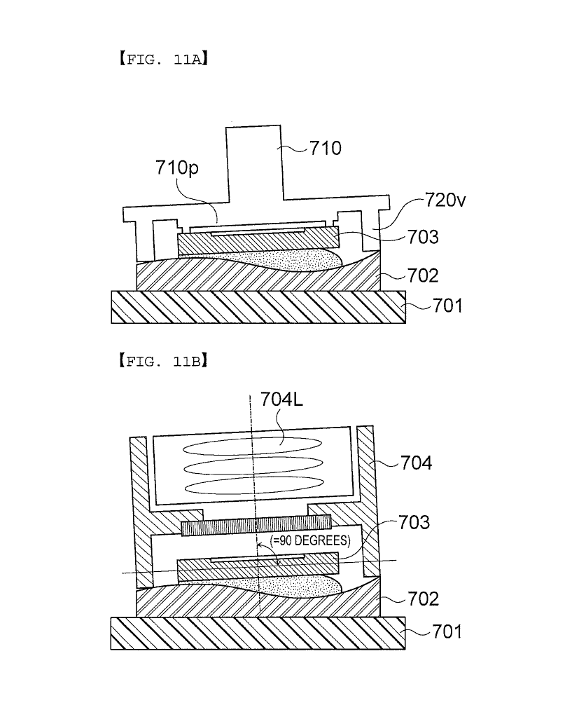

As shown in FIGS. 10A and 10B, when a D/A process is performed by using an apparatus for manufacturing a camera module according to the related art, an image sensor 603 may be tilted due to flatness of a PCB 602 and other problems, as shown in FIG. 10A. Here, in the case where a housing 604 is finally attached onto the PCB 602, an excessive accumulative tolerance may be generated, which is difficult to overcome, as shown in FIG. 10B.

However, as shown in FIGS. 11A and 11B, when a D/A process is performed by using an apparatus for manufacturing a camera module according to the present invention, even though an image sensor 703 is tilted due to flatness of a PCB 702 and other problems, as shown in FIG. 11A, verticality between an optical axis of the lens 704L and the image sensor is maintained at 90 degree when a housing 704 is finally attached onto the PCB 702, and thus, an excessive accumulative tolerance can be overcome.

According the apparatus for manufacturing a camera module of the present invention, a separate PCB holding unit is formed outside the image sensor pickup part of the rim tool, so that, the mounting levels of the lens housing module and the image sensor can be made to be equal to each other when the image sensor is picked up by the image sensor pickup part and then attached onto the PCB. Therefore, the mounting tilt of the image sensor is varied together according to the tilt of the PCB in the die attach (D/A) process, thereby solving the problem in that the tilt of the image sensor is changed according to the tilt of the PCB. Hence, the present invention can prevent the degradation in resolution due to the image sensor being tilted as described in the related art, and reducing related costs for repairing and managing the camera module. In addition, the present invention can obtain effects of substitution for an alignment adjusting process, improvement in productivity due to that, and reduction in investment costs.

As set forth above, in the present invention, a separate PCB holding unit is formed outside the image sensor pickup part of the rim tool, so that, the mounting levels of the lens housing module and the image sensor can be made to be equal to each other when the image sensor is picked up by the image sensor pickup part and then attached onto the PCB. Therefore, the mounting tilt of the image sensor is varied together according to the tilt of the PCB in the die attach (D/A) process, thereby solving the problem in that the tilt of the image sensor is changed according to the tilt of the PCB. Hence, the present invention can prevent the degradation in resolution due to the image sensor being tilted as described in the related art, and reducing related costs for repairing and managing the camera module. In addition, the present invention can obtain effects of substitution for an alignment adjusting process, improvement in productivity thereby, and reduction in investment costs.

Although the exemplary embodiments of the present invention have been disclosed for illustrative purposes, the present invention is not limited thereto, and it will be appreciated to those skilled in the art that various modifications, additions and substitutions are possible, without departing from the scope and spirit of the invention as disclosed in the accompanying claims. Therefore, the protection scope of the present invention must be construed by the following claims and it should be construed that all spirit within a scope equivalent thereto are included in the scope of the present invention.

What is claimed is:

1. An apparatus for manufacturing a camera module, the apparatus comprising:
a base jig holding a PCB from below;
a rim tool picking up an image sensor and attaching the image sensor onto the PCB; and
a housing bonding tool picking up a housing assembly and attaching the housing assembly onto the PCB so that the image sensor attached onto the PCB is received in the housing assembly,
wherein a PCB holding unit is formed integrally with an image sensor pickup part of the rim tool outside the image sensor pickup part, the PCB holding unit being contacted with the PCB to hold the PCB when the image sensor is picked up by the image sensor pickup part and attached onto the PCB.

2. The apparatus according to claim 1, wherein the PCB holding unit is composed of, based on a central point of the image sensor pickup part of the rim tool, a horizontal plane part extended toward an outside of the image sensor pickup part in all directions by a predetermined width, and a vertical member formed downwardly from an edge of the horizontal plane part perpendicularly to the horizontal plane part by a predetermined length.

3. The apparatus according to claim 2, wherein the vertical member is formed in a type of barrier wall, which entirely surrounds the image sensor pickup part.

4. The apparatus according to claim 2, wherein the vertical member is formed in a type of one pair of wall surface structures at least facing each other outside of the image sensor pickup part.

5. The apparatus according to claim 2, wherein the vertical member is formed in a type of plural pillar members outside the image sensor pickup part.

6. The apparatus according to claim 1, wherein the image sensor pickup part is constituted in a vacuum type or a grip type.

7. The apparatus according to claim 1, wherein the image sensor pickup part has contact protrusions constituted in any one of a square shape, a circular shape, and a discontinuous rod shape.
